(19) United States
(12) Patent Application Publication
(10) Pub. No.: US 2009/0288522 A1
(43) Pub. Date: Nov. 26, 2009

(54) SOCKET AND A METHOD FOR MAKING THE SAME

(76) Inventor: Ching-Hsing TSENG, Taichung (TW)

Correspondence Address: OSTROLENK FABER GERB & SOFFEN, 1180 AVENUE OF THE AMERICAS, NEW YORK, NY, 100368403, US

(21) Appl. No.: 12/193,876

(22) Filed: Aug. 19, 2008

(30) Foreign Application Priority Data
May 26, 2008 (TW) 097119357

(51) Int. Cl. B25B 13/06; B23P 17/00

(52) U.S. Cl. 81/121.1; 29/592

(57) ABSTRACT

A socket includes a tubular metallic body, a corrosion-resistant layer unit, a pattern unit, and a corrosion-resistant protection layer unit. The tubular metallic body has an outer peripheral surface, which includes a first peripheral portion and a second peripheral portion. The second peripheral portion has a non-patterned region and a patterned region. The non-patterned region exhibits a body color. The corrosion-resistant layer unit is provided on the first peripheral portion. The pattern unit is provided on the patterned region of the second peripheral portion. The corrosion-resistant protection layer unit is provided on at least the pattern unit. The pattern unit is imparted with an anti-corrosion property and a color property distinguishable from the body color exhibited by the non-patterned region.

### CROSS-REFERENCE TO RELATED APPLICATION

This application claims priority of Taiwanese Application No. 097119357, filed on May 26, 2008.

### BACKGROUND OF THE INVENTION

1. Field of the Invention

The invention relates to a socket, more particularly to a socket which is improved in pattern distinction and corrosion resistance. The invention also relates to a method for making the socket.

2. Description of the Related Art

Referring to FIG. 1, a conventional socket 1 has an outer peripheral surface 101, and a pattern region 102 formed at the outer peripheral surface 101 to indicate a specification or size of the socket 1.

During manufacture of the socket 1, a recess unit 102′ is formed through a roller-engraving technique, and a corrosion-resistant layer is formed to cover the outer peripheral surface 101 and the recess unit 102′ through a manganese phosphate treatment, a plating treatment, or the like. Since the outer peripheral surface 101 and the recess unit 102′ are covered with the corrosion resistant layer, it is relatively difficult for a user to recognize the pattern region 102.

Referring to FIG. 2, another conventional socket 2 likewise has an outer peripheral surface 201 and a pattern region 202 formed at the outer peripheral surface 201 to indicate a specification or size of the socket 2.

During manufacture of the socket 2, a corrosion-resistant layer is formed to cove the outer peripheral surface 201 through a manganese phosphate treatment, a plating treatment, or the like, and the pattern region 202 is subsequently formed through a laser-engraving technique. The corrosion-resistant layer near the pattern region 202 is liable to be worn away after a period of use, which in turn makes the pattern region 202 difficult to be recognized by the user.

### SUMMARY OF THE INVENTION

Therefore, an object of the present invention is to provide a socket which is improved in pattern distinction and corrosion resistance. Another object of the present invention is to provide a method for making the socket.

In the first aspect of this invention, a socket includes a tubular metallic body, a corrosion-resistant layer unit, a pattern unit, and a corrosion-resistant protection layer unit. The tubular metallic body has an outer peripheral surface. The outer peripheral surface includes a first peripheral portion and a second peripheral portion. The second peripheral portion has a non-patterned region and a patterned region. The non-patterned region exhibits a body color. The corrosion-resistant layer unit is provided on the first peripheral portion. The pattern unit is provided on the patterned region of the second peripheral portion. The corrosion-resistant protection layer unit is provided on at least the pattern unit. The pattern unit is imparted with an anti-corrosion property and a color property distinguishable from the body color exhibited by the non-patterned region.

In the second aspect of this invention, a method for making a socket includes the steps of: a) preparing a tubular metallic body having an outer peripheral surface, the outer peripheral surface including a first peripheral portion and a second peripheral portion; b) providing a pattern unit on the second peripheral portion, thereby configuring the second peripheral portion with a patterned region having the pattern unit, and a non-patterned region; and c) subjecting the outer peripheral surface to corrosion-resistance treatment to form a corrosion-resistant layer unit provided on the first peripheral portion and a corrosion-resistant protection layer unit provided on at least the pattern unit. The pattern unit is imparted with an anti-corrosion property and a color property distinguishable from a body color exhibited by the non-patterned region.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view of a conventional socket;

FIG. 2 is a schematic view of another conventional socket;

FIG. 3 is a schematic view of a first preferred embodiment of a socket according to this invention;

FIG. 4 is a sectional view of the first preferred embodiment;

FIG. 5 is a flow chart of a method for making the first preferred embodiment;

FIGS. 6 to 10 are views illustrating steps of the method for making the first preferred embodiment;

FIG. 11 is a flow chart of a method for making a second preferred embodiment of a socket according to this invention;

FIG. 12 is a sectional view of a third preferred embodiment of a socket according to this invention;

FIG. 13 is a flow chart of a method for making the third preferred embodiment; and

FIG. 14 to 17 are views illustrating steps of the method for making the third preferred embodiment.

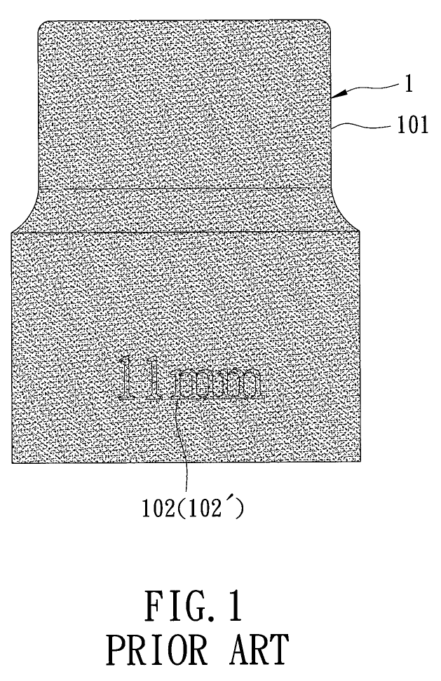

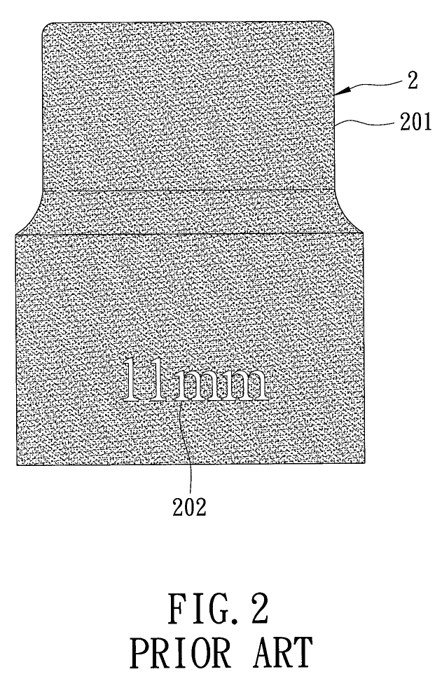

### DETAILED DESCRIPTION OF THE PREFERRED EMBODIMENTS

Before the present invention is described in greater detail, it should be noted that like elements are denoted by the same reference numerals throughout the disclosure.

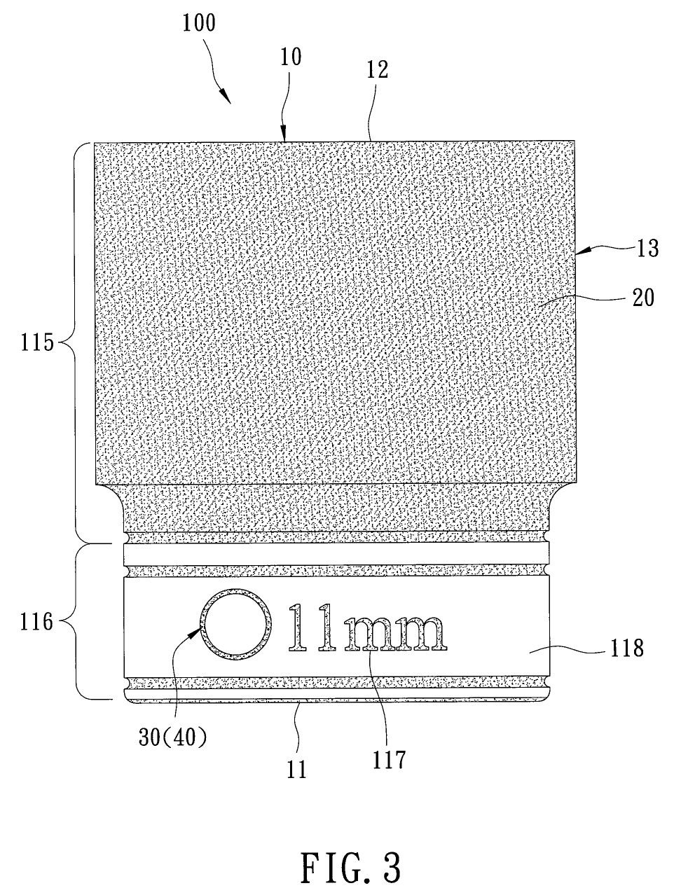

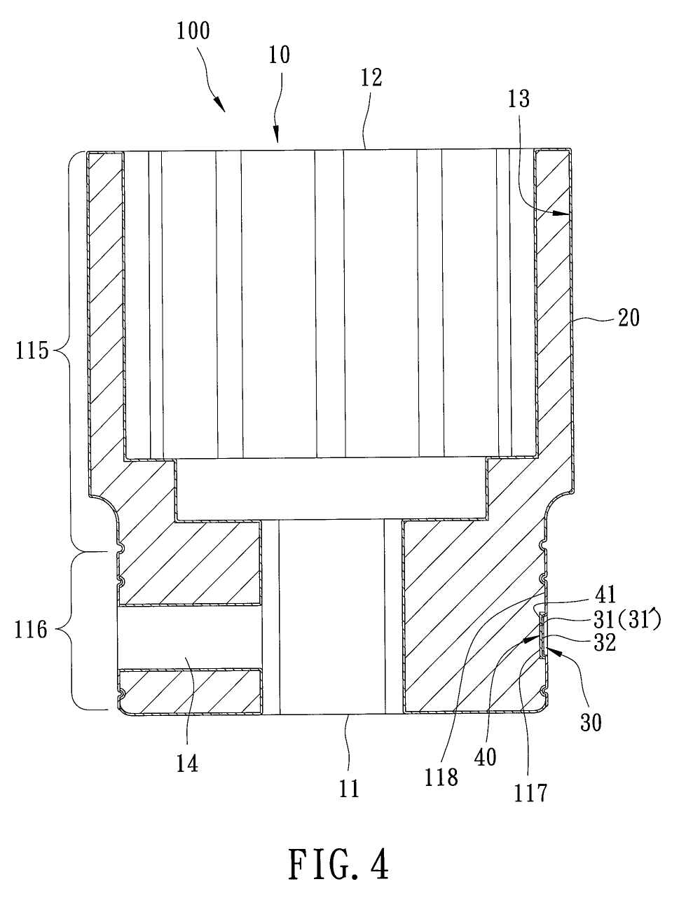

Referring to FIGS. 3 and 4, the first preferred embodiment of a socket 100 according to this invention is shown to include includes a tubular metallic body 10, a corrosion-resistant layer unit 20, a pattern unit 40, and a corrosion-resistant protection layer unit 30.

The tubular metallic body 10 includes an operating end 11 adapted for connection to a tool (not shown), a working end 12 opposite to the operating end 11 and adapted for engaging a work piece (such as a bolt), an outer peripheral surface 13 extending between the operating end 11 and the working end 12, and a hole 14 extending radially and inwardly from the outer peripheral surface 13. The outer peripheral surface 13 includes a first peripheral portion 115 proximate to the working end 12, and a second peripheral portion 116 proximate to the operating end 11. The second peripheral portion 116 has a non-patterned region 118 and a patterned region 117. In this embodiment, the non-patterned region 118 is a grind-finished surface exhibiting a body color, which is an original color attributed to material of the tubular metallic body 10. The hole 14 extends radially and inwardly from the non-patterned region 118 of the second peripheral portion 116, and is adapted for installation of a spring-loaded ball unit (not shown) used to retain the socket 100 on the tool.

The corrosion-resistant layer unit 20 is provided on the first peripheral portion 115, and exhibits a color different from the body color of the non-patterned region 118.

The pattern unit 40 is provided on the patterned region 117 of the second peripheral portion 116, and includes a recess unit 41 formed in the patterned region 117 of the second peripheral portion 116. The pattern unit 40 includes characters showing the specification and/or the size of the socket 100, and/or a trademark of the manufacturer of the socket 100.

The corrosion-resistant protection layer unit 30 is provided on the second peripheral portion 116, and includes a filling sub-layer 31 that fills the recess unit 41 to impart the pattern unit 40 with an anti-corrosion property and a color property distinguishable from the body color exhibited by the non-patterned region 118, and a transparent sub-layer 32 that covers the filling sub-layer 31 and that surrounds the second peripheral portion 116. The filling sub-layer 31 is a manganese phosphate treated layer, an anodized layer, a plated layer, a baked coating layer, or the like. The transparent sub-layer 32 is a corrosion-resistant oil layer or a transparent plastic layer. The pattern unit 40 is thereby imparted with the anti-corrosion property and the color property distinguishable from the body color exhibited by the non-patterned region 118.

It should be noted herein that the socket 100 can include two or more second peripheral portions 116, which are spaced apart from each other, and each of which is formed with the patterned region 117.

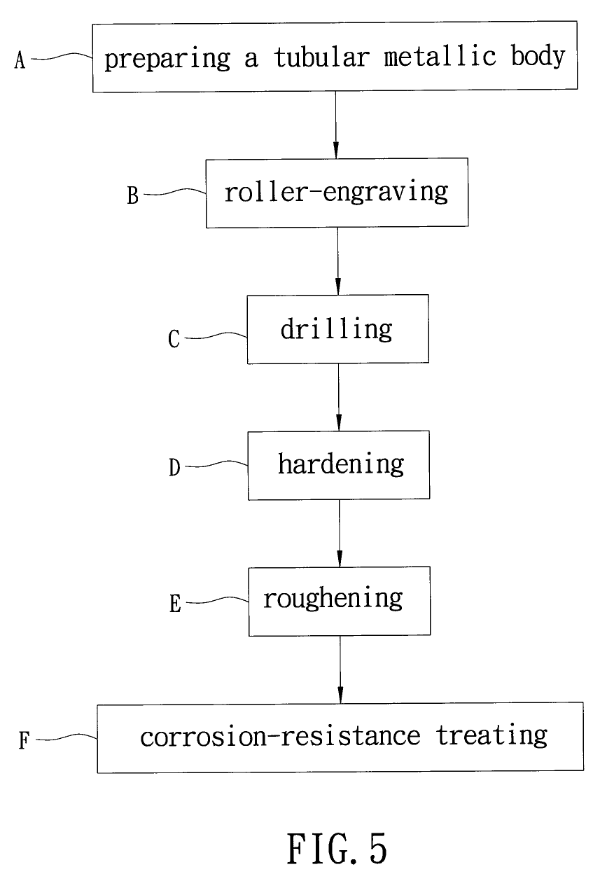

Referring to FIG. 5, a method for making the first preferred embodiment of the socket 100 according to this invention includes the steps of:

A) Preparing the Tubular Metallic Body 10:

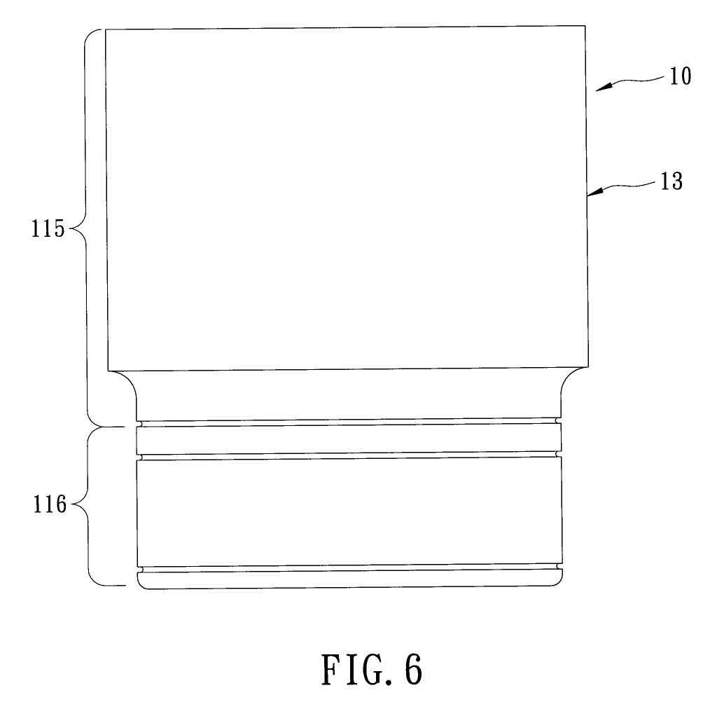

Referring to FIG. 6, the tubular metallic body 10 is prepared, which has the outer peripheral surface 13. The outer peripheral surface 13 includes the first peripheral portion 115 and the second peripheral portion 116.

B) Roller-Engraving:

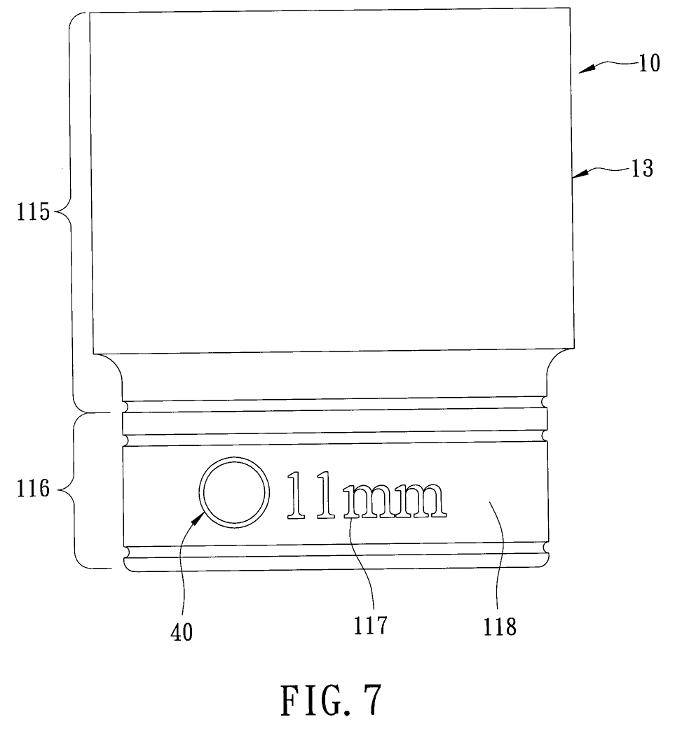

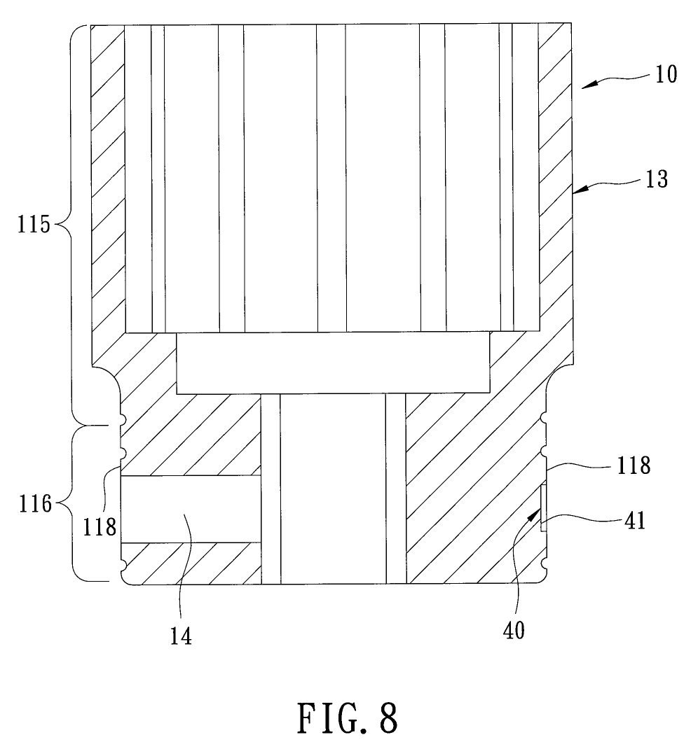

Referring to FIGS. 7 and 8, the tubular metallic body 10 is provided with a pattern unit 40 on the second peripheral portion 116 through roller-engraving techniques, thereby configuring the second peripheral portion 116 with a patterned region 117 having the pattern unit 40, and a non-patterned region 118. The pattern unit 40 is a recess unit 41 formed in the patterned region 117 of the second peripheral portion 116.

C) Drilling:

Referring again to FIG. 8, the tubular metallic body 10 is drilled to form a hole 14 extending radially and inwardly from the non-patterned region 118 of the second peripheral portion 116 of the outer peripheral surface 13. The hole 14 can be installed with a spring-loaded ball unit (not shown) for retaining the socket 100 on a tool (not shown).

D) Hardening:

The tubular metallic body 10 is hardened via a heat treatment.

E) Roughening:

The outer peripheral surface 13 of the tubular metallic body 10 is roughened via a sand-blasting treatment.

F) Corrosion-Resistance Treating:

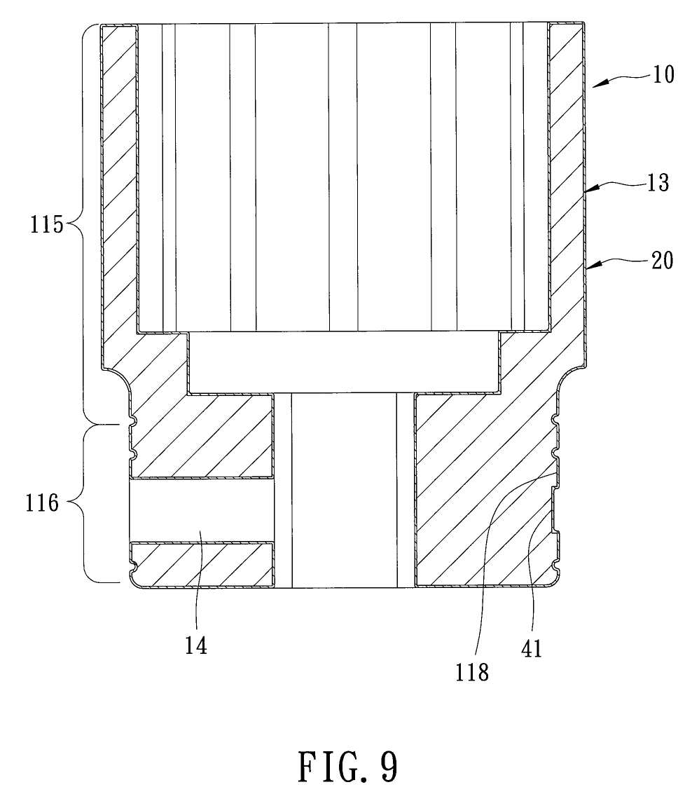

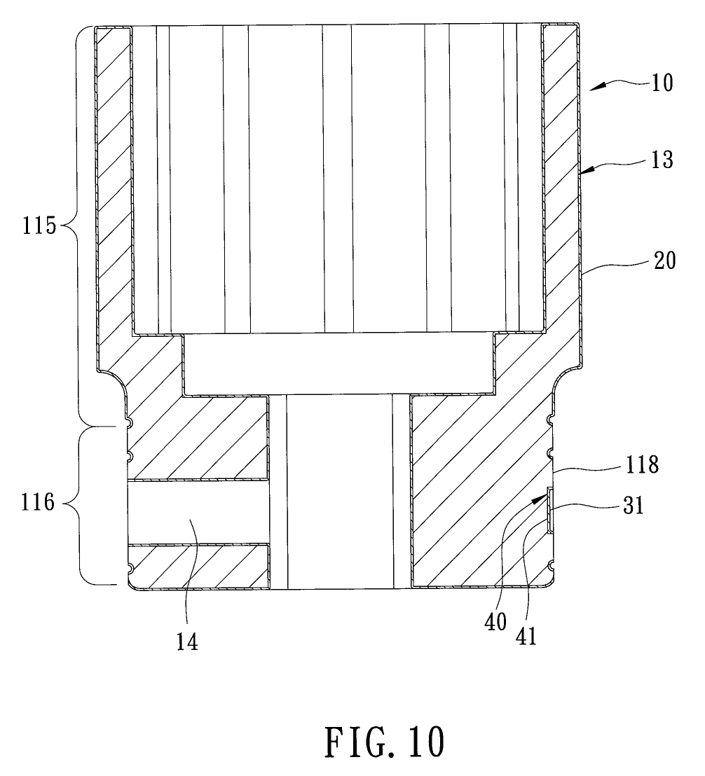

Referring FIGS. 4, 9 and 10, the outer peripheral surface 13 of the tubular metallic body 10 is subjected to corrosion-resistance treatment to form the corrosion-resistant layer unit 20 provided on the first peripheral portion 115, and a corrosion-resistant protection layer unit 30 provided on the second peripheral portion 116. The corrosion-resistant protection layer unit 30 includes a filling sub-layer 31 that fills the recess unit 41 to impart the pattern unit 40 with the anti-corrosion property and the color property distinguishable from the body color exhibited by the non-patterned region 118. In particular, the corrosion-resistance treatment includes: forming the corrosion-resistant layer unit 20 on the first peripheral portion 115 and the filling sub-layer 31 on the pattern unit 40 via a manganese phosphate treatment, an anodization treatment, a plating treatment, or a baked coating treatment, followed by grinding the second peripheral portion 116 so that the non-patterned region 118 of the second peripheral portion 116 becomes a grind-finished surface exhibiting the body color distinguishable from the color property imparted by the filling sub-layer 31 to the pattern unit 40; and providing the transparent sub-layer 32 to the second peripheral portion 116. The transparent sub-layer 32 can be a corrosion-resistant oil layer or a transparent plastic layer. The grinding of the second peripheral portion 116 can be performed by any suitable grinding techniques, such as centerless grinding, external grinding, turning, cloth wheel grinding, sand wheel grinding, or the like. Preferably, the tubular metallic body 10 is cleaned via supersonic washing prior to providing the transparent sub-layer 32 to the second peripheral portion 116.

Referring again to FIGS. 3 and 4, the second preferred embodiment of a socket 100 according to this invention is similar to the first preferred embodiment, except for the following. The patterned region 117 of the second peripheral portion 116 is a sand-blasted surface that imparts the pattern unit 40 with the color property distinguishable from the body color, and the non-patterned region 118 of the second peripheral portion 116 is a grind-finished surface exhibiting the body color, which is an original color attributed to the material of the tubular metallic body 10. Furthermore, the corrosion-resistant protection layer unit 30 includes a corrosion-resistant oil sub-layer 31′ that fills the recess unit 41 to impart the pattern unit 40 with the anti-corrosion property, and the transparent sub-layer 32 that surrounds the second peripheral portion 116. The transparent sub-layer 32 can be a corrosion-resistant oil layer or a transparent plastic layer.

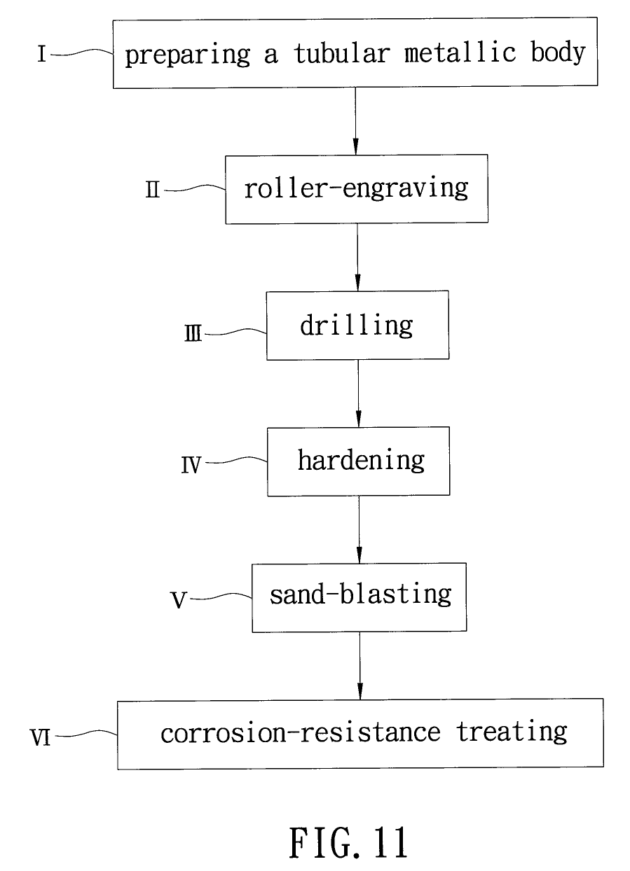

Referring to FIGS. 4 and 11, a method for making the second preferred embodiment of the socket 100 according to this invention is similar to the method for making the first preferred embodiment, except for the following. The outer peripheral surface 116 of the tubular metallic body 10 is roughened prior to the corrosion-resistance treatment. In particular, the outer peripheral surface 13 of the tubular metallic body 10 is subjected to sand-blasting to roughen the same. In the corrosion-resistance treating step, a corrosion-resistant oil is applied on the outer peripheral surface 13 such that the corrosion-resistant protection layer unit 30 includes a corrosion-resistant oil sub-layer 31′ that fills the recess unit 41 to impart the pattern unit 40 with the anti-corrosion property. The second peripheral portion 13 is subjected to grinding processing so that the non-patterned region 118 of the second peripheral portion 116 becomes a grind-finished surface exhibiting the body color, and so that the patterned region 117 of the second peripheral portion 116 maintains a sand-blasted surface that imparts the pattern unit 40 with the color property distinguishable from the body color. The transparent sub-layer 32 is then provided to surround the second peripheral portion 116.

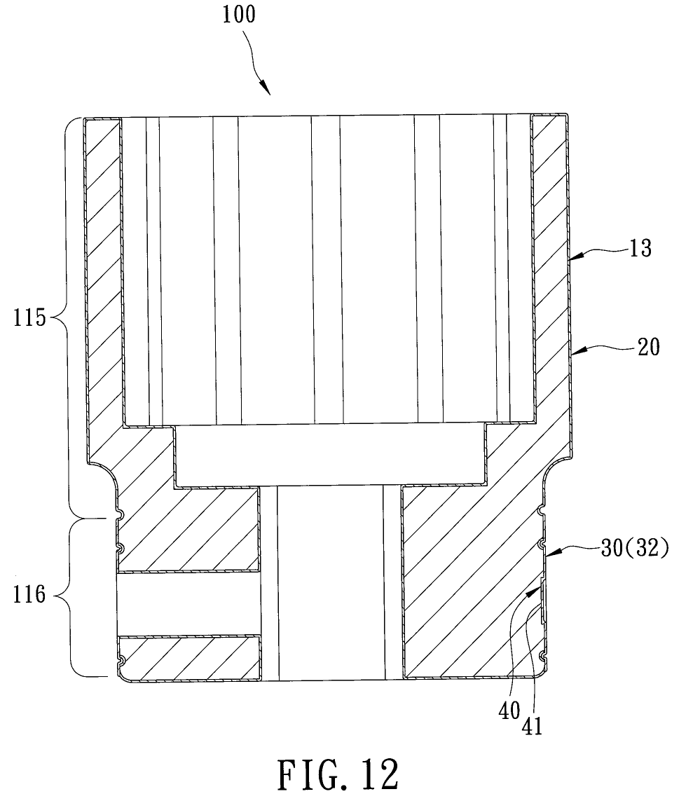

Referring to FIG. 12, the third preferred embodiment of a socket 100 according to this invention is similar to the first preferred embodiment, except for the following. The recess unit 41 is a laser-engraved recess unit that imparts the pattern unit 40 with the color property distinguishable from the body color, which is an original color attributed to the material of the tubular metallic body 10 exhibited by the non-patterned region 118. The corrosion-resistant protection layer unit 30 is a corrosion-resistant oil sub-layer that is applied on the second peripheral portion 116. Alternatively, the corrosion-resistant protection layer unit 30 can be a transparent plastic sub-layer that surrounds the second peripheral portion 116.

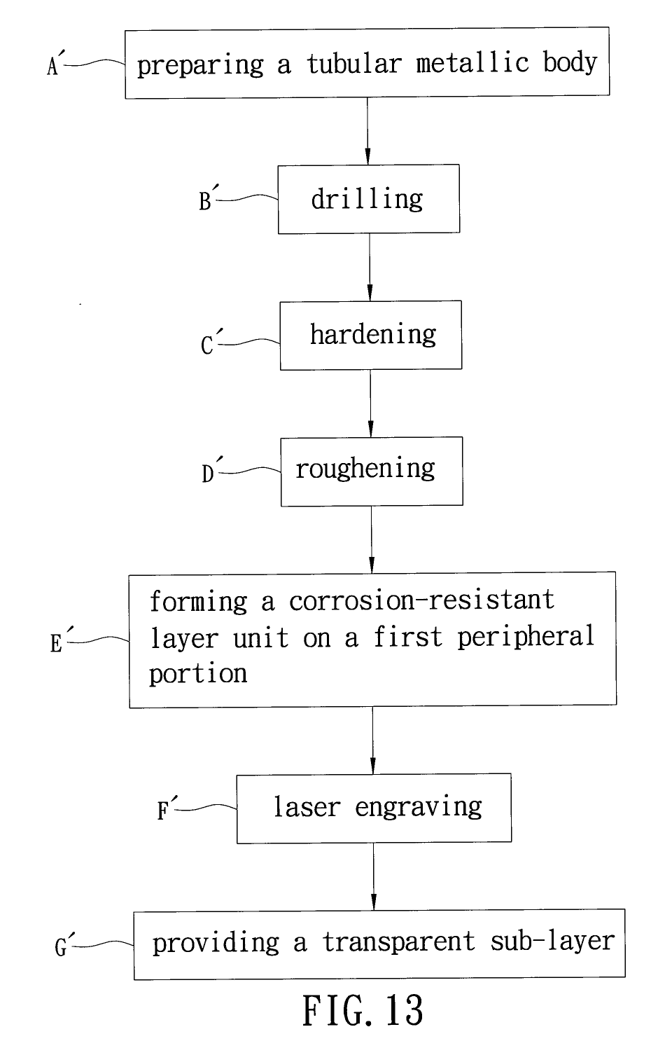

Referring to FIG. 13, a method for making the third preferred embodiment of the socket 100 according to this invention includes the steps of:

A′) Preparing the Tubular Metallic Body 10:

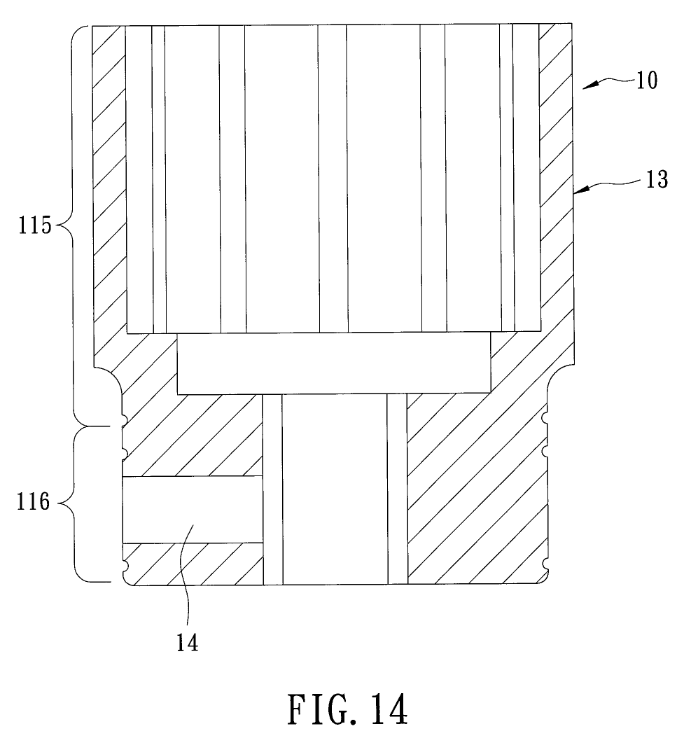

Referring to FIG. 14, the tubular metallic body 10 is prepared, which has the outer peripheral surface 13. The outer peripheral surface 13 includes the first peripheral portion 115 and the second peripheral portion 116.

B′) Drilling:

Referring again to FIG. 14, the tubular metallic body 10 is drilled to form a hole 14 extending radially and inwardly from the second peripheral portion 116 of the outer peripheral surface 13.

C′) Hardening:

The tubular metallic body 10 is hardened via a heat treatment.

D′) Roughening:

The outer peripheral surface 13 of the tubular metallic body 10 is roughened via a sand-blasting treatment.

E′ ) Forming the Corrosion-Resistant Layer Unit 20 on the First Peripheral Portion 115:

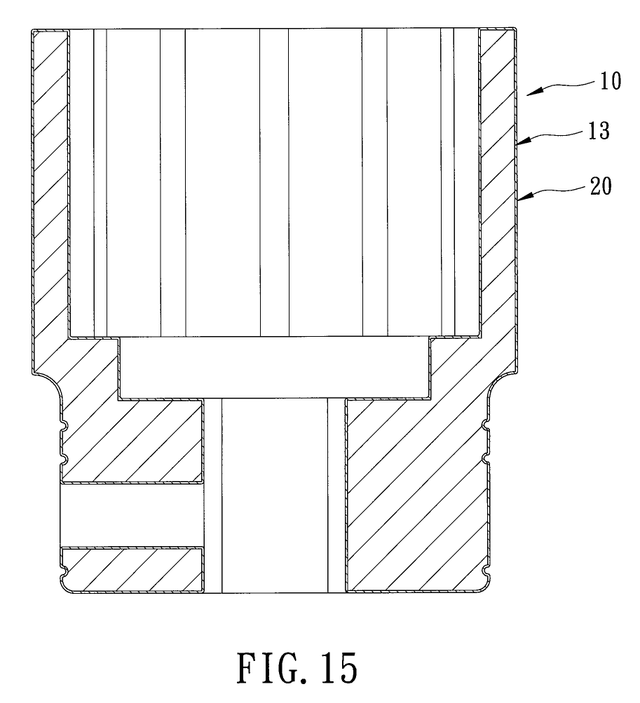

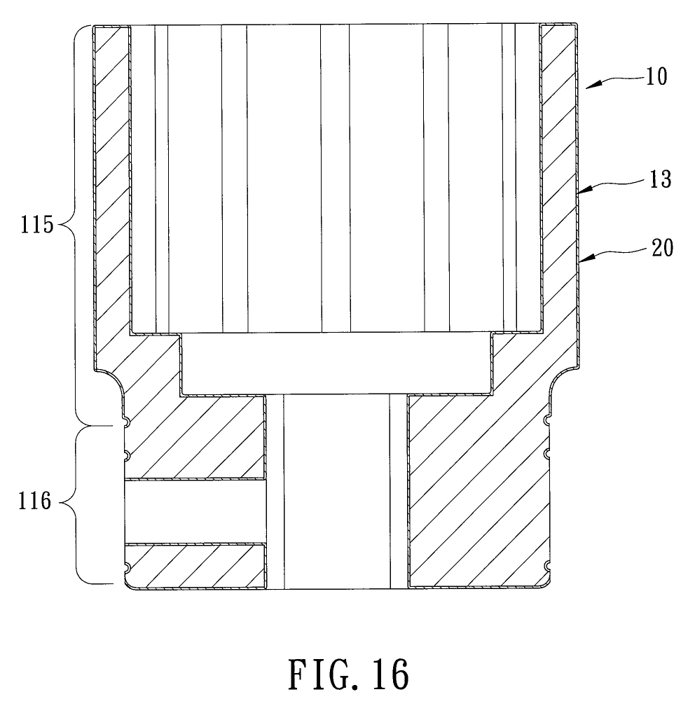

Referring FIGS. 15 and 16, the outer peripheral surface 13 of the tubular metallic body 10 is subjected to a manganese phosphate treatment, an anodization treatment, a plating treatment, or a baked coating treatment so as to form the corrosion-resistant layer unit 20 on the first peripheral portion 115, followed by grinding the second peripheral portion 116.

F′) Laser-Engraving:

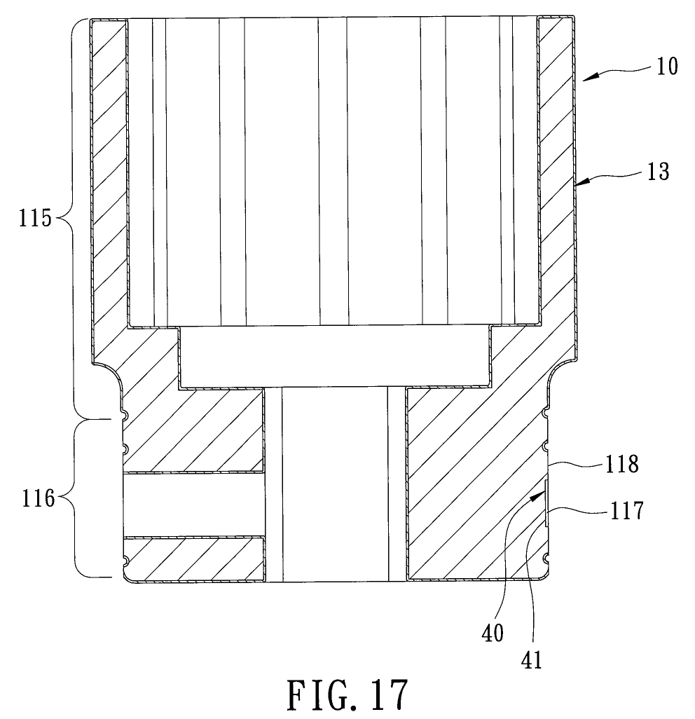

Referring to FIG. 17, the second peripheral portion 116 is laser-engraved to form the recess unit 41 in the second peripheral portion 116, thereby configuring the second peripheral portion 116 with the patterned region 117 having the pattern unit 40 and imparting the pattern unit 40 with the color property distinguishable from the body color exhibited by the non-patterned region 118 of the second peripheral portion 116.

G′) Providing the Transparent Sub-Layer 32:

Referring again to FIG. 12, the transparent sub-layer 32 is provided to surround the second peripheral portion 116 to form the corrosion-resistant protection layer unit 30.

In view of the aforesaid, since the pattern unit 40 of the socket 100 of the present invention is imparted with the anti-corrosion property and the color property distinguishable from the body color exhibited by the non-patterned region 118, the pattern distinction and corrosion resistance of the socket 100 of the present invention are improved over the prior art.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

We claim:

1. A socket, comprising:
a tubular metallic body having an outer peripheral surface, said outer peripheral surface including a first peripheral portion and a second peripheral portion, said second peripheral portion having a non-patterned region and a patterned region, said non-patterned region exhibiting a body color;
a corrosion-resistant layer unit provided on said first peripheral portion;
a pattern unit provided on said patterned region of said second peripheral portion; and
a corrosion-resistant protection layer unit provided on at least said pattern unit;
wherein said pattern unit is imparted with an anti-corrosion property and a color property distinguishable from the body color exhibited by said non-patterned region, and
wherein the body color is an original color attributed to material of said tubular metallic body.

2. The socket as claimed in claim 1, wherein said pattern unit includes a recess unit formed in said patterned region of said second peripheral portion.

3. The socket as claimed in claim 2, wherein said corrosion-resistant protection layer unit includes a filling sub-layer that fills said recess unit to impart said pattern unit with the anti-corrosion property and the color property distinguishable from the body color exhibited by said non-patterned region.

4. The socket as claimed in claim 3, wherein said filling sub-layer is one of a manganese phosphate treated layer, an anodized layer, a plated layer, and a baked coating layer.

5. The socket as claimed in claim 3, wherein said corrosion-resistant protection layer unit further includes a transparent sub-layer that surrounds said second peripheral portion.

6. The socket as claimed in claim 2, wherein said non-patterned region of said second peripheral portion is a grind-finished surface exhibiting the body color, and said patterned region of said second peripheral portion is a sand-blasted surface that imparts said pattern unit with the color property distinguishable from the body color exhibited by said non-patterned region.

7. The socket as claimed in claim 6, wherein said corrosion-resistant protection layer unit includes a corrosion-resistant oil sub-layer that fills said recess unit to impart said pattern unit with the anti-corrosion property.

8. The socket as claimed in claim 7, wherein said corrosion-resistant protection layer unit further includes a transparent sub-layer that surrounds said second peripheral portion.

9. The socket as claimed in claim 2, wherein said recess unit is a laser-engraved recess unit that imparts said pattern unit with the color property distinguishable from the body color exhibited by said non-patterned region.

10. The socket as claimed in claim 9, wherein said corrosion-resistant protection layer unit includes a corrosion-resistant oil sub-layer that is applied on said second peripheral portion.

11. The socket as claimed in claim 9, wherein said corrosion-resistant protection layer unit includes a transparent plastic sub-layer that surrounds said second peripheral portion.

12. A method for making a socket, comprising the steps of:
a) preparing a tubular metallic body having an outer peripheral surface, the outer peripheral surface including a first peripheral portion and a second peripheral portion;
b) providing a pattern unit on the second peripheral portion, thereby configuring the second peripheral portion with a patterned region having the pattern unit, and a non-patterned region; and
c) subjecting the outer peripheral surface to corrosion-resistance treatment to form a corrosion-resistant layer unit provided on the first peripheral portion and a corrosion-resistant protection layer unit provided on at least the pattern unit;
wherein the pattern unit is imparted with an anti-corrosion property and a color property distinguishable from a body color exhibited by the non-patterned region, and
wherein the body color is an original color attributed to material of the tubular metallic body.

13. The method as claimed in claim 12, wherein the pattern unit includes a recess unit formed in the patterned region of the second peripheral portion.

14. The method as claimed in claim 13, wherein the step b) is conducted through roller-engraving techniques.

15. The method as claimed in claim 13, wherein the corrosion-resistant protection layer unit includes a filling sub-layer that fills the recess unit to impart the pattern unit with the anti-corrosion property and the color property distinguishable from the body color exhibited by the non-patterned region.

16. The method as claimed in claim 15, wherein the step c) includes forming the filling sub-layer through a treatment selected from the group consisting of a manganese phosphate treatment, an anodization treatment, a plating treatment, and a baked coating treatment.

17. The method as claimed in claim 15, wherein the step c) includes providing a transparent sub-layer on the second peripheral portion.

18. The method as claimed in claim 13, further comprising the step of roughening the outer peripheral surface of the tubular metallic body prior to the step c), wherein the outer peripheral surface of the tubular metallic body is subjected to sand-blasting to roughen the outer peripheral surface.

19. The method as claimed in claim 18, wherein the step c) includes applying a corrosion-resistant oil on the outer peripheral surface such that the corrosion-resistant protection layer unit includes a corrosion-resistant oil sub-layer that fills the recess unit to impart the pattern unit with the anti-corrosion property.

20. The method as claimed in claim 19, further comprising subjecting the second peripheral portion to grinding processing so that the non-patterned region of the second peripheral portion becomes a grind-finished surface exhibiting the body color, and so that the patterned region of the second peripheral portion maintains a sand-blasted surface that imparts the pattern unit with the color property distinguishable from the body color exhibited by the non-patterned region.

21. The method as claimed in claim 20, further comprising providing a transparent sub-layer that surrounds the second peripheral portion.

22. The method as claimed in claim 13, wherein the recess unit is formed through laser-engraving techniques and imparts the pattern unit with the color property distinguishable from the body color exhibited by the non-patterned region.

23. The method as claimed in claim 22, wherein the step c) includes, prior to step b), a sub-step of forming the corrosion-resistant layer unit on the first peripheral portion.

24. The method as claimed in claim 23, wherein the step c) further includes, after step b), a sub-step of providing a transparent sub-layer that surrounds the second peripheral portion to form the corrosion-resistant protection layer unit.
